(19) United States
(12) Patent Application Publication
(10) Pub. No.: US 2026/0001555 A1
(43) Pub. Date: Jan. 1, 2026

(54) METHOD FOR DETERMINING THE DRIVABILITY OF A ROUTE SECTION

(71) Applicant: HELLA GMBH & CO. KGAA, Lippstadt (DE)

(72) Inventors: Simon Dwucet, Welver (DE); Wladimir Fischer, Liesborn (DE); Samra Hrnjicic, Erwitte (DE); Friedrich Keller, Lippstadt (DE); Carolin Santuens, Geseke (DE); Michael Skutek, Erwitte (DE)

(21) Appl. No.: 19/249,462

(22) Filed: Jun. 25, 2025

(30) Foreign Application Priority Data
Jun. 28, 2024 (DE) 102024118432.9

(51) Int. Cl. B60W 40/02

(52) U.S. Cl. CPC B60W 40/02; B60W 2554/404

(57) ABSTRACT

The present invention relates to a method for determining the drivability of a route section by a vehicle. The route section includes at least one object with an actual height, such as a roadway boundary, a tunnel ceiling or a bridge. The actual height of the object extends at least in sections along a vertical, the object is located at least in sections in front of the vehicle in the direction of travel.

### CROSS-REFERENCE TO RELATED APPLICATIONS

The present application claims the benefit of German Patent Application No. 10-2024-118-432.9, filed Jun. 28, 2024, the disclosure of which is incorporated by reference.

### BACKGROUND OF THE INVENTION

The invention relates to a method, a computer program product, a computer-readable data carrier, an electronic control unit, and a vehicle.

Vehicles are known to have sensors, for example radar sensors, LIDAR, cameras and/or ultrasonic sensors, to detect static objects (and/or moving objects). In particular, static objects such as roadway boundaries on the side (e.g. guard rails, noise barriers) and/or above the roadway (e.g. bridges, overpasses, tunnel ceilings) as well as at ground level (e.g. curbs) can be detected in the process. For example, height determination and/or height measurement can be carried out along a vertical line. As a function thereof, the drivability of the route section can be determined. For example, a vehicle with a height that is too high (e.g. 350 cm) cannot drive on or through a route section that comprises a bridge with a lower height (e.g. 340 cm). This can also be referred to as drivability (not applicable in this example). Similarly, a vehicle with insufficient ground clearance (e.g. 10 cm) cannot drive on or over a route section that comprises an edge with a greater height (e.g. 15 cm). If drivability is applicable, a route section can be traversed. Distance information, in particular the distance to the object, can also be determined. This can be measured during operation of the vehicle, in particular during (autonomous and/or at least partially automated) driving, for example using a driver assistance system, and/or used to operate the vehicle.

Here, the state of the art has disadvantages. In the case of radar sensors, for example, it may not be possible to determine, in particular a drivability of a route section located in front of the vehicle (along a direction of travel), for example with regard to the (actual) height of an object (e.g. a tunnel), or it may only be possible to reliably determine a determined height using a radar sensor in a short range (e.g. 0 to 7 m). In other words, it may be that (only) at short range the determined height (substantially) corresponds to the actual height of the object (e.g. with an error of less than 5%). In a more distant range and/or long range located in front thereof in the direction of travel (e.g. 7 m to 100 m), a determination may be unreliable and/or ambiguous. Here, multiple reflections (in particular on the ground) and/or signal distortions can occur, which distort and/or contaminate the radar signal and/or the raw data. This effect can be stronger with increasing distance from the object along the direction of travel. As a result, a height determined (by the radar sensor and/or an electric control unit) can deviate (greatly) from the actual height of the object along the vertical. The short range and/or long range (or their dimensions along the direction of travel) may depend on the sensor, the vehicle and/or the positioning (in particular angle and/or installation height) of the sensor on the vehicle. Thus, in the long range, the height of the object cannot be determined or can only be determined unreliably. Thus, autonomous and/or (partially) automated driving cannot be enabled (or only to a limited extent) during operation, in particular at higher speeds. This can also reduce safety, in particular due to false detections. This may also reduce comfort. Using other (further) sensors or sensor types (in addition) may (unfavorably) increase costs, complexity, weight and/or the required installation space. At the same time, (already) measured and/or reliable information, e.g. a determined height at short range, cannot be used any further by the vehicle and/or other road users (e.g. other vehicles).

### SUMMARY OF THE INVENTION

The present invention is based on the object of at least partially overcoming at least one of the disadvantages described above. One such object is to provide an improved method for determining the drivability of a route section. Furthermore, another object is to optimize safety, accuracy, (possible) speed when driving, reliability, robustness, costs, complexity, weight, required installation space, data usage (utilization) and/or confidence (of the driver in the vehicle).

The above object is achieved by a method with the features of the independent method claim, a computer program product with the features of the independent patent claim relating to a computer program product, a computer-readable data carrier with the features of the independent patent claim relating to a computer-readable data carrier, an electronic control unit with the features of the independent patent claim relating to an electronic control unit and a vehicle with the features of the independent vehicle claim. Further features and details of the invention are apparent from the subclaims, the description and the drawings. Here, features and details described in connection with the method according to the invention of course also apply in connection with the computer program product according to the invention and/or in connection with the computer-readable data carrier according to the invention and/or in connection with the electronic control unit according to the invention and/or in connection with the vehicle according to the invention and vice versa, so that with regard to the disclosure reference is or can always be made reciprocally to the individual aspects of the invention. In particular, advantages described in the context of the first, second, third, fourth and/or fifth aspect also apply to the first, second, third, fourth and/or fifth aspect, respectively.

The above object is achieved according to a first aspect by a method for determining a drivability of a route section by a vehicle (e.g. according to the fifth aspect), wherein the route section has at least one object with an actual (or real) height (along the vertical), for example a roadway boundary, a tunnel ceiling or a bridge, wherein the actual height of the object extends at least in sections along a vertical, wherein the object (and/or the route section) is located at least in sections in front of the vehicle in the direction of travel, comprising the method providing, in particular by measuring and/or loading from a memory unit, to a electronic control unit (preferably according to the fourth aspect), at least two sets of measurement data. Each of the at least two sets of measurement data comprises: measured values, in particular raw data and/or a determined height of the object, from at least one measurement cycle of a radar measurement by a sensor of the vehicle, the measured values being specific for a certain distance of the sensor from the object along the direction of travel. Each of the at least two sets of measurement data further includes at least two measurement data, which are specific to the measured values. The method further includes determining, by the electronic control unit, of a feature vector having at least one entry (or value for the entry), the at least one entry being calculated as a function of the at least two measurement data, and classifying, by the electronic control unit, of the feature vector using a trained classifier in order to determine a first drivability of the route section.

The method according to the first aspect may be computer-implemented and/or may be carried out repeatedly and/or continuously. Preferably, the method can be carried out when, prior to and/or (preferably) during operating a vehicle and/or a electronic control unit or the use of a vehicle and/or a electronic control unit. Here, operating may be (manual) driving, autonomous driving and/or (at least partially) automated driving. Alternatively or additionally, the method can be carried out at (regular) intervals (e.g. speed-dependent). It is conceivable, for example, that the method is carried out while a vehicle is traveling along a route section. It is also conceivable that the method is activated when the journey begins or is (foreseeably) about to begin, for example to support a (un) parking process. This allows obstacles to be detected early and/or warnings to be issued. This can prevent the driver (or the vehicle's driver assistance system) from overlooking an object, for example. Here, the electronic control unit can (at least partially) implement the method, for example by (combined) performing the (above-mentioned) steps and/or controlling the corresponding components (e.g. the sensors). The method can be used to process and/or detect the drivability of a route section located in front of the vehicle along a direction of travel more efficiently, more accurately, more reliably, more cost-effectively, with less weight, less installation space and/or more quickly.

In the context of the invention, a vehicle may comprise a motor vehicle and/or a truck. Here, a vehicle can be equipped for operation, in particular for autonomous and/or (at least partially) automated driving.

The drivability of a route section can be positive or negative. For example, positive drivability may mean that the vehicle can drive on, through, and/or over the route section. For example, negative drivability may mean that the vehicle cannot drive on, through and/or over the route section.

A route section can preferably extend in front of the vehicle in the direction of travel. The route section can preferably have dimensions and/or partial areas which comprise the short range and long range, in particular of the (radar) sensor. For example, the route section can cover a distance of between 0 and (maximum) 100 m, in particular 0 to 50 m, preferably 0 to 30 m. Here, the route section can extend along the direction of travel (from the vehicle in the direction of travel) and/or along the (perpendicular) vertical (from bottom to top). Thus, the route section can be two-dimensional. For example, the route section can cover a height along the vertical from about 0 m (ground) to (about) 6 m (above the ground), in particular if the vehicle is a maximum of 4 m high. For the sake of simplicity, a two-dimensional route section can be assumed in the context of the invention. However, the method and/or the invention can of course also be applied to a three-dimensional route section (e.g. with an extension along a transverse direction [from right to left and/or perpendicular to the direction of travel and/or the vertical]), in particular to a solid angle extending forwards. Here, it may be preferably be provided to use conventional and/or known radar sensors. Preferably, it may be provided that the method is (also) used with existing vehicles and/or (radar) sensor(s). This can save costs and/or increase the safety of known vehicles. The vehicle can preferably move along the direction of travel when operating and/or driving. Thus, the route section can change (in the process and/or continuously). In the process, an object moves closer accordingly. In particular, an object that initially “appears” in the long range can come closer and closer (distance along the direction of travel decreases) until it is finally in the short range before the object is in particular driven on, driven through and/or driven over. It may be particularly preferred that a (first) drivability is already determined according to the invention, preferably in a long range. Continuously and/or subsequently, in particular while the object is at a long range and approaching, the (first) drivability can be determined again and/or repeatedly. The (first) drivability can be determined based on the sets of measurement data already determined (which have already been recorded and/or with greater distances). In the process, the accuracy can increase and/or improve with an increasing number of sets of measurement data. Here, the invention can be based on the idea that different (characteristic) sets of measurement data result depending on the distance to the object, the actual height of the object (or the height sections in which the object is located), the installation height of the sensor in the vehicle and (or) the (multiple) reflections, in particular on the ground. Here, different (repeating and/or characteristic) patterns can occur in the raw data and/or measurement data, depending on which a first drivability can be determined. Thus, a (first) drivability can be determined by evaluating the sets of measurement data over time, in particular without necessarily (directly) determining the height of the object in the process. When the object enters the short range, it may be provided that the accuracy increases and/or that a (second) drivability can be determined, which preferably has a (significantly) greater accuracy and/or reliability. Here, the second drivability can be achieved by directly determining the height of the object via the radar. If it is detected that a collision with the object could occur, for example due to a negative (first and/or second) drivability, the electronic control unit can stop operating and/or driving and/or reduce the speed and/or initiate an evasive maneuver and/or issue a warning message (to the driver).

The object can preferably be located within the route section, and in particular move gradually and/or continuously (relative to the vehicle), in particular approaching (reducing the distance between the vehicle and the object). Thus, the vehicle and/or the sensor can approach (drive towards) a static object (located in front of the vehicle along the direction of travel). Here, the object can have a realistic and/or actual (physical) height, in particular along a vertical. Here, the object can extend along the vertical at least partially over one or more (e.g. twenty and/or equidistant) vertical sections. Here, an object along the vertical can cover the entire route section, for example a building. Alternatively, for example, a bridge and/or a tunnel can cover an actual height (in sections) in an area above the ground, e.g. above 450 cm or from 450 cm to 490 cm, relative to the ground.

Providing, in particular by measuring and/or loading from a memory unit to an electronic control unit (preferably according to the fourth aspect), of at least two sets of measurement data can be carried out by continuous and/or repeated measurement in the process, in particular while the vehicle is moving towards the object along the direction of travel. Here, in the simplest case, a set of measurement data can comprise a detection or a corresponding set of data from a (radar) sensor. The measurement can be carried out by a (radar) sensor, which is connected to the electronic control unit in particular via a data connection for data communication. This means that it can be made available to the electronic control unit. The measurement can be carried out by a radar measurement, which is set up to determine the (determined) height, wherein in particular the determined height is specific to the actual height of the object. Here, a set of measurement data can (in each case) have measured values, in particular raw data and/or a determined height of the object, from at least one measurement cycle of a radar measurement by a sensor of the vehicle, the measured values being specific for a certain distance of the sensor from the object along the direction of travel, and at least two sets of measurement data which are specific for the measured values. Here, the measurement data can be determined based on the measured values and/or derived from them (see below). Here, it may be provided for a set of measurement data to (only) contain the raw data of a radar measurement, in particular a measurement cycle. It may also be provided that the raw data is (already) processed, for example comprising a distance Doppler matrix and/or a determined height (e.g. to determine a second drivability). Here, it may be provided that a determined height is not (directly) used to determine the (first) drivability. It may be provided that providing, determining and/or classifying is based (exclusively) on raw data and/or (processed) signals. Here, a (potentially) existing determined height can be used (only) for a second drivability check for validation and/or in a short range (see below). Here, a measurement cycle and/or a set of measurement data may contain information about the short range and/or the long range. For the sake of simplicity, it is assumed in these explanations that only one object is to be detected. However, if there are multiple objects, this can also be processed using the method. In the process, in particular these objects can be separated in a first step in order to obtain separate sets of measurement data for different objects. It may be provided (see above) that a (substantially) accurate determination of the detected height is possible within a short range (e.g. 0 to 7 m). In a long range (greater distance than short range), it may be provided that no unambiguous and/or sufficiently accurate determination of the height measured (by conventional distance measurement) can be achieved, in particular because reflections and/or multiple reflections (e.g. on the ground) occur. Thus, a first drivability can be carried out according to the invention by detecting and/or classifying as a function of the sets of measurement data, in particular the measured values, which can be specific to the reflections and/or multiple reflections.

Determining, by the electronic control unit, a feature vector with at least one entry (or value for the entry), in particular with at least two, three, four and/or a plurality of entries, with the at least one entry being calculated as a function of the at least two measurement data, may in the process comprise calculating the entry or the (individual) entries, in particular according to a predefined scheme (determined in particular as part of training). For example, the current and/or previously measured sets of measurement data can be used to determine the measurement data as a function of the corresponding measured values (see below). The entry or entries (or their values) can then be calculated as a function of the (current) measurement data, in particular using the variables (explained below). Here, an entry may also contain a (linear) combination and/or multiplication between such measurement data or variables. For example, a difference between the maximum and minimum SNR for a specific set of measurement data or (preferably) for the previous sets of measurement data can generate a value or entry. Here, the accuracy of the classification to obtain the first drivability can increase with an increasing number of sets of measurement data. This may be based on the idea that the (multiple) reflections and/or distortions in the radar signals can then be assigned with increasing accuracy to a (first) drivability by the classifier. Which entries and how the entries are calculated (e.g. via which mathematical function) can preferably be determined by training.

Classifying, by the electronic control unit, of the feature vector using a trained classifier in order to determine the first drivability of the route section here can be carried out by the classifier, which uses the (current) feature vector as input. Here, the classifier can be set up, in particular by training, to assign certain measurement data to a (positive or negative) first drivability. Thus, it may be provided that a first drivability is positive if (currently) drivability of the route section is detected by the classifier. Thus, it may be provided that a first drivability is negative if the drivability of the route section is not (currently) detected by the classifier or if the classifier detects that the route section is not drivable.

In the context of the invention, it may be advantageous for the measurement data to comprise at least one, preferably two or more, variables derived from the sets of measurement data, in particular the measured values, in particular: at least one value derived from a respectively determined height, at least one variable derived from a respectively determined signal-to-noise ratio, and/or at least one derived variable, which is determined as a function of a number of targets in one or more bins of the measured values, a bin being specific to a section along the vertical defined in particular by the electronic control unit.

Here, it may be provided that the measurement data is mathematically derived and/or calculated as a function of and/or based on the measured values, in particular the raw data. Here, this can refer to a mathematical derivation (differentiation). However, a different type of calculation is also possible.

Here, a value derived from a (respectively) determined height can be specific for a determined height of a set of measurement data. For example, in the process it can be determined: a maximum height (e.g. MaxHeight) and/or minimum height (e.g. MinHeight), which is specific for a maximum value of a determined height among the respectively determined heights of the different measured values (different sets of measurement data), an interval (e.g. HeightSpan), which is specific for a minimum value and a maximum value of a determined height (among the sets of measurement data), wherein in particular the minimum value is subtracted from the maximum value (by subtraction), an average height (e.g. MeanHeight), which is specific for an average value of the determined height(s) of the different measured values (different sets of measurement data), and/or a standard deviation (e.g. HeightStdDev), which is specific for a standard deviation of the values of the determined heights of the different measured values (different sets of measurement data).

Here, a variable derived from a (respectively) determined signal-to-noise ratio can be specific for the signal-to-noise ratio of the measured value or measured values or sets of measured data. Here, the signal-to-noise ratio can be determined based on the raw data. For example, in the process it can be determined: a minimum value for the signal-to-noise ratio of the different sets of measurement data, in particular the raw data, which is specific to the measured values, a maximum value for the signal-to-noise ratio, an interval (e.g. SNRSpan), which is specific to the minimum value and the maximum value of the signal-to-noise ratio, a standard deviation for the signal-to-noise ratio, which is specific to the measured values determined, and/or an average signal-to-noise ratio.

Here, the following can be calculated, for example, as or for a derived variable, which is determined as a function of a number of targets in one or more bins (preferably comprising the object) of the measured values, a bin being specific for a section defined along the vertical defined in particular by the electronic control unit: a minimum value for the number of targets, a maximum value for the number of targets, an interval, which is specific to the minimum and maximum value of the number of targets, a standard deviation for the number of targets, and/or an average number of targets.

For example, a feature vector could have three entries, which are calculated based on the at least two and/or more sets of measurement data measured so far, wherein the first entry has a (current) interval (e.g. HeightSpan), which is specific for a minimum value and a maximum value of a determined height (among the sets of measurement data), e.g. maximum height 350 cm, minimum height 280 cm→subtraction→interval=70 cm, the second entry contains a (currently) maximum determined height, e.g. 350 cm, and the third entry contains a (current) product (multiplication) between the standard deviation for the determined heights and the average height.

Here, as part of training, it can be defined which entries (to be determined) are to be determined (at all) (i.e. which of the above measurement data or variables are to be used). The actual entries can then be calculated based on the current (measured) sets of measurement data, in particular during operating and/or carrying out the method.

In the context of the invention, it is conceivable that, prior to providing, defining of the entries of the feature vector to be determined is carried out, wherein defining is carried out by training the classifier, wherein in particular the entries to be determined are determined by training as a function of a statistical significance, in particular for a first drivability of the route section.

Here, defining can be carried out by the electronic control unit. Here, as a basis, (a large number) of previously measured sets of measurement data can be used, preferably comprising sets of measurement data specific to both the long range and the short range (used as the gold standard). Here, the invention can adopt the idea that, at short range, the determined height corresponds (substantially) to the actual height of the object. One object may therefore be to enable the drivability and/or height to be determined as reliably as possible, even at long range. The sets of data used for training and/or defining can therefore be used to generate entries for the feature vector using a plurality of different measurement data and/or (derived) variables (see above). Depending on the feature vectors, classifying can be carried out in each case in order to determine a first drivability. Using the sets of measurement data, in particular the determined heights, which are specific to the short range, the classifier can then check whether a (first) drivability was actually given and/or justified. Thus, training or learning can be carried out based on the information from the long range (which is used as the gold standard or ground truth). This makes it possible to determine during training which entries should ideally be determined during (subsequent) operation and/or which have the highest statistical significance. For example, it can be determined as part of training (see example above) that three entries have the highest statistical significance, which are calculated based on the at least two and/or more sets of measurement data measured so far, wherein the first entry (to be determined) has a (current) interval (e.g. HeightSpan), which is specific for a minimum value and a maximum value of a determined height (among the sets of measurement data), the second entry contains a (currently) maximum determined height, and the third entry contains a (current) product (multiplication) between the standard deviation for the determined heights and the average height.

As a result, the corresponding entry can be determined later during operation based on the (then) current and/or measured sets of measurement data. Based on this, the classifier can determine a first drivability. As the vehicle approaches and/or further sets of measurement data are measured, the classifier can determine and/or refine the first drivability again and/or repeatedly. At the latest when the vehicle and/or the sensor enter the short range, the result of the first drivability can be checked and/or validated. Here, checking may involve comparing the height determined (at short range) (which in all probability corresponds to the actual height), in particular an average value of the height determined at short range, with the vehicle height (in particular comprising an additional safety distance). If the vehicle height is lower than the determined height, (first and/or second) drivability is positive. If the classifier also determines a correct (e.g. positive) first drivability based on the sets of measurement data specific to the long range, the entries can be used accordingly. By using a plurality of different combinations of measurement data (sets) and/or (derived) variables, it is possible to determine which entries (to be determined) are most suitable (have the greatest statistical significance). For example, the classifier can have a maximum likelihood classifier. It is also conceivable that the classifier has a Bayesian classifier. It would also be conceivable to use an artificial neural network. It may preferably be provided that training is (only) carried out by the electronic control unit during (initial) operation of the vehicle. This may be based on the idea that there is a dependency on the vehicle and/or the installation geometry (in particular the installation height) of the sensor. Thus, for one (each) vehicle and/or sensor, a respective optimized training can be enabled. This can improve accuracy and/or reliability.

In the context of the invention, it may be provided that when determining and/or defining the at least one entry, in particular the entry to be determined, is carried out by a mathematical combination, in particular a linear combination and/or multiplication, at least partially as a function of the at least two measurement data.

Here, the entry (to be determined) can have a (mathematical) function. Here, an entry (to be determined) can be designed as a function of the at least two measurement data and/or variables (described above), for example. To return to the above example, it may be provided that the (third) entry contains a (current) product (multiplication) between the standard deviation for the determined heights and the average height.

Of course, another combination of the above variables is also conceivable (see above). Here, the training and/or classifier can be set up to determine the most suitable entry or entries (to be determined). Here, in particular the following combinations are conceivable, wherein a and b are different measurement data and/or (derived) variables:

$$a * b$$

$$\frac{a}{b}$$

$${a}^{2} * {b}^{2}$$

$$\frac{{a}^{2}}{{b}^{2}}$$

$${a}^{2} + {b}^{2}$$

$$\sqrt{{a}^{2} + {b}^{2}}$$

By combining different measurement data and/or variables, a reduction of (undesired) interference can be achieved. In the process, the statistical significance can be increased. This allows an improved classifying to be provided.

It is also conceivable that classifying comprises an assigning to at least two classes, comprising a first class which is specific for route sections which can be traversed by the vehicle, in particular (characteristic) for a (maximum or minimum) height which can be traversed by the vehicle, in particular driven through and/or driven over, the first drivability being positive, and a second class which is specific for route sections which cannot be traversed by the vehicle, in particular (characteristic) for a (maximum or minimum) height which cannot be traversed by the vehicle, in particular cannot be driven through and/or cannot be driven over, the first drivability being negative.

Here, the height can be specific to the height value specific to the vehicle (e.g. overall height, in particular comprising a safety clearance) and/or ground clearance value (e.g. ground clearance below the vehicle, in particular comprising a safety clearance).

It is also conceivable that classifying is carried out as a function of the feature vector and at least one reference feature vector, which is determined in particular by training.

Here, in particular the feature vector can be determined as a function of current data. Here, the reference feature vector can be used as a gold standard and/or ground truth. It may be provided that a plurality of reference feature vectors is determined (by training). This allows a reference feature vector to be created for different constellations of objects and/or route sections. This can enable (comparatively) fast classifying.

In the context of the invention, it is optionally possible that the radar measurement at least partially exhibits a distance-dependent signal distortion and/or a multipath reflection of radar waves, for which the measurement data are specific, wherein in particular the classifier, in particular during classifying and/or by training, is set up to detect the signal distortion and/or multipath reflection as a function of the feature vector, wherein (and/or whereby) in particular a classification into a first class and a second class is carried out.

Here, a first drivability of the route section can be determined by the vehicle. Here, a multipath reflection on the ground can occur due to reflections at different locations (distances) on the ground between the vehicle and the object. The radar waves reflected from the object cannot (at least in part) allow (unambiguous and/or reliable) calculation of the determined height. The multipath reflections or multiple reflections can lead to signal distortion. Here, depending on the geometric constellations between the sensor, the ground and/or the object (in particular over time or at different distances), classifying can be carried out depending on the measurement data and/or variables (see above), wherein a classification into a first class (positive drivability) and a second class (negative drivability) can preferably be carried out.

Furthermore, it may be provided in the context of the invention that determining a second drivability of the route section is carried out by the electronic control unit as a function of a determined height of the object, wherein the determined height is comprised by the measured values for a certain distance and/or is determined as a function thereof, wherein a second drivability is positive if the determined height, in particular all determined heights, is greater than a height value specific to the vehicle or is less than a ground clearance value specific to the vehicle, and a second drivability is negative if the determined height, in particular all determined heights, is less than a height value specific to the vehicle or greater than a ground clearance value specific to the vehicle.

Here, it may be provided that determining is carried out by the sensor and/or the electronic control unit, in particular as a function of the transit time difference(s) of the radar measurement. In other words, a (conventional) determination of the determined height can be carried out, which can be highly reliable, in particular in the short range. In the long range, it may be provided that the determination (only) provides an insufficient and/or ambiguous determined height. It may be provided that the determining is carried out in addition to, always and/or in parallel with the method according to the invention. For example, determining a determined height may comprise: providing a plurality of measured values (loading of hard disk and/or measuring) as a function of at least the received radar waves, each measured value being characterized by a direct distance to the object and a vertical angle (relative to the direction of travel or height of the sensor) relative to the direction of travel, classifying, by an electronic control unit, the total measurement height (the field of view of the sensor along the vertical) into a plurality of bins, each bin being specific to a section of the total measurement height (and the bins together covering the total height), assigning, by the electronic control unit, each measured value of the plurality of measured values to one bin of the plurality of bins depending on the vertical angle and the direct distance of the measured value and the section for which the corresponding bin is specific, calculating, by the electronic control unit, a probability (e.g. via an evidence-based calculation) for each bin of the plurality of bins that the object is actually located at least partially in that bin, and/or determining, by the electronic control unit, a determined height as a function of the probability.

Here, this may comprise transmitting, by a sensor, transmitted radar waves, wherein the transmitted radar waves cover at least one total measurement height of the sensor along the vertical. Here, this may comprise receiving, by the sensor, received radar waves which correspond at least partially to transmitted radar waves reflected from the object. Here, the bins can each have a vertical bin height, which is set by the electronic control unit, in particular depending on the resolution of the sensor, in particular specifically for a certain measuring cycle. In this way, the entire (actual) height of the object and/or the measurement range along the vertical can be covered. Here, the determined height can be a total height of the object and/or a distribution or occupation of the (different) bins along the vertical. In other words, it can be determined in which bins (i.e. which sections along the vertical) the object is located (and in which not). The determined height and/or the raw data and/or the (other) determined information can (subsequently) be provided as a set of measurement data.

With reference to the present invention, it is conceivable that, in particular after determining a second drivability of the route section, a decision is made by the electronic control unit, wherein the decision is made as a function of the distance and a distance limit value, wherein in particular the distance limit value is specific for a boundary between a short range and a long range, wherein a final drivability corresponds to the first drivability if the distance is greater than (or equal to) the distance limit, and a final drivability corresponds to the second drivability if the distance is less than (or equal to) the distance limit value.

Here, the distance limit value can be preset, e.g. to 7 m, wherein the short range is (substantially) located below the distance limit value and/or the long range is (substantially) located above the distance limit value. The distance limit value can alternatively or additionally be determined and/or readjusted by training and/or simulation. For example, a first and second drivability can be determined for a plurality of distances, wherein a comparison with a gold standard is then obtained, which can correspond in particular to the determined height, which is determined for distances below a reliability distance (e.g. below 2 m or 1 m). Here, it may be provided that the distance limit is defined in such a way that, at greater distances (long range), the first drivability is always more likely to be correct and, at shorter distances (in particular at short range), the second drivability is always correct. This enables an optimized determination of the drivability for each distance.

Furthermore, it is conceivable that, in particular after and/or as a function of classifying, the distance limit value is adjusted by the electronic control unit, in particular during operation of the vehicle, wherein a first drivability and a second drivability are determined for different distances, in particular for all distances to be traversed, and are compared with a last, in particular the last two or three, values for a determined height, in particular in the short range.

Here, a determined height in the short range, in particular below the reliability distance, can correspond to a gold standard and/or ground truth. Here, for example, an average value can be carried out for the determined heights, which are specific to sets of measurement data with a distance below the reliability distance. Here, for example, it can be determined whether the standard deviation is low (enough), e.g. less than 5% in relation to the average value. This means that the actual height of the object can be (or was) determined as reliably as possible. In the context of the invention, it can be advantageous that, in particular after and/or as a function of classifying, a retraining is carried out, in particular during operation of the vehicle, wherein in particular the reference vector is readjusted as a function of a determined height, which is in particular specific for a set of measurement data that is determined in a short range (of the sensor and/or vehicle).

This enables the classifier to be retrained. Here (as described above), the determined height in the short range, in particular below the reliability distance, can be considered correct. This may be due in particular to low (or no) distortion and/or multiple reflections in the short range. Here, it may be provided that a vehicle will gradually move from the long range to the short range, which may (sooner or later) result in a measurement in the short range. As a result, a distance can be assigned to each set of measurement data (or vice versa). Here, the short range (or its dimensions), e.g. 6 to 8 m in front of the sensor, can depend on the vehicle, the sensor, the installation height and/or the installation angle of the sensor in relation to the vehicle.

The above object is achieved according to a second aspect by a computer program product according to the invention, comprising commands which, when the computer program product is executed by a computer, in particular an electronic control unit, cause the computer to implement the method according to the first aspect.

This results in the same advantages with respect to a computer program product according to the invention as have already been described with respect to a method according to the invention according to the first aspect.

The above object is achieved according to a third aspect by a computer-readable data carrier according to the invention, in which commands are stored which, when executed by a computer, in particular an electronic control unit, cause the computer to carry out the method according to the first aspect.

This results in the same advantages with respect to a computer-readable data carrier according to the invention as have already been described with respect to a method according to the invention according to the first aspect and/or a computer program product according to the invention according to the second aspect.

The above object is achieved according to a fourth aspect by a control unit comprising a computing unit and a memory unit in which commands are stored which, when at least partially executed by the computing unit, carry out a method according to the first aspect.

This results in the same advantages with respect to an electronic control unit according to the invention as have already been described with respect to a method according to the invention according to the first aspect and/or a computer program product according to the invention according to the second aspect and/or a computer-readable data carrier according to the invention according to the third aspect.

The above object is achieved according to a fifth aspect by a vehicle according to the invention, comprising an electronic control unit according to the fourth aspect.

This results in the same advantages with respect to a vehicle according to the invention as have already been described with respect to a method according to the invention according to the first aspect and/or a computer program product according to the invention according to the second aspect and/or a computer-readable data carrier according to the invention according to the third aspect and/or an electronic control unit according to the invention according to the fourth aspect.

### BRIEF DESCRIPTION OF THE DRAWINGS

Further advantages, features and details of the invention are apparent from the following description, in which several embodiment examples of the invention are described in detail with reference to the drawings. Here, the features mentioned in the claims and in the description can each be essential to the invention individually or in any combination. In the figures:

FIG. 1 is a method,

FIG. 2 is a vehicle, and

FIG. 3 is a determined height as a function of a distance to the object.

### DETAILED DESCRIPTION OF THE CURRENT EMBODIMENT

In the figures, the same technical features, including those of different embodiment examples, are represented by identical reference signs.

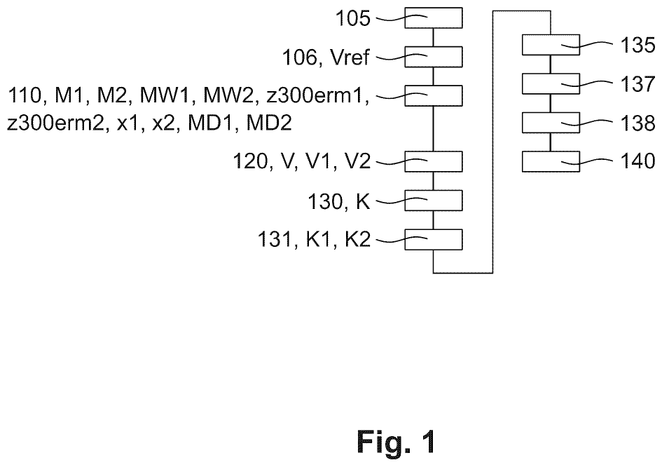

FIG. 1 shows a method for determining a drivability of a route section R by a vehicle 200, wherein the route section R has at least one object with an actual height z300real, for example a roadway boundary, a tunnel ceiling or a bridge, wherein the actual height z300real of the object extends at least in sections along a vertical, wherein the object is located at least in sections in front of the vehicle in the direction of travel, the method comprising: providing, to an electronic control unit ECU, at least two sets of measurement data M1, M2. Each of the at least two sets of measurement data M1, M2 comprising: measured values MW1, MW2, in particular raw data and/or a determined height z300erm1, z300erm2 of the object, from at least one measurement cycle of a radar measurement by a sensor of the vehicle, the measured values MW1, MW2 being specific for a certain distance x1, x2 of the sensor from the object along the direction of travel, and at least two measurement data MD1, MD2, which are specific to the measured values MW1, MW2. The method further comprises determining, by the electronic control unit ECU, of a feature vector with at least one entry V1, V2, the at least one entry V1, V2 being calculated as a function of the at least two measurement data MD1, MD2, and classifying, by the electronic control unit ECU, of the feature vector using a trained classifier in order to determine a first drivability of the route section R.

In the context of the invention, it may be advantageous for the measurement data MD1, MD2 to comprise at least one, preferably two or more, variables derived from the sets of measurement data M1, M2, in particular the measured values MW1, MW2, in particular: at least one variable derived from a respectively determined height z300erm1, z300erm2, at least one variable derived from a respectively determined signal-to-noise ratio, and/or at least one derived variable, which is determined as a function of a number of targets in one or more bins of the measured values MW1, MW2, a bin being specific to a section along the vertical defined in particular by the electronic control unit ECU.

In the context of the invention, it is conceivable that, prior to providing, defining of the entries V1, V2 of the feature vector to be determined is carried out, wherein defining is carried out by training the classifier, wherein in particular the entries V1, V2 to be determined are determined by training as a function of a statistical significance, in particular for a first drivability of the route section R.

In the context of the invention, it may be provided that when determining and/or defining the at least one entry V1, V2, in particular the entry to be determined, is carried out by a mathematical combination, in particular a linear combination and/or multiplication, at least partially as a function of the at least two measurement data MD1, MD2.

It is also conceivable that classifying comprises an assignment to at least two classes K1, K2, comprising a first class which is specific for route sections R which can be traversed by the vehicle, in particular for a height which can be traversed by the vehicle, the first drivability being positive, and a second class which is specific for route sections R which cannot be traversed by the vehicle, in particular for a height which cannot be traversed by the vehicle, the first drivability being negative.

It is also conceivable that classifying is carried out as a function of the feature vector and at least one reference feature vector, which is determined in particular by training.

In the context of the invention, it is optionally possible for the radar measurement to have at least partially a distance-dependent signal distortion and/or a multipath reflection of radar waves, for which the measurement data MD1, MD2 are specific, wherein in particular the classifier, in particular during classifying and/or by training, is set up to detect the signal distortion and/or multipath reflection as a function of the feature vector, wherein in particular a classification into a first class and a second class is carried out.

Furthermore, it may be provided in the context of the invention that a determining a second drivability of the route section R is carried out by the electronic control unit ECU as a function of a determined height z300erm1, z300erm2 of the object, wherein the determined height z300erm1, z300erm2 is comprised of the measured values MW1, MW2 for a specific distance x1, x2 and/or is determined as a function thereof, wherein a second drivability is positive if the determined height z300erm1, z300erm2, in particular all determined heights z300erm1, z300erm2, is greater than a height value specific to the vehicle or is less than a ground clearance value specific to the vehicle, and a second drivability is negative if the determined height z300erm1, z300erm2, in particular all determined heights z300erm1, z300erm2, is less than a height value specific to the vehicle or is greater than a ground clearance value specific to the vehicle.

With reference to the present invention, it is conceivable that, in particular after determining a second drivability of the route section R, a decision is made by the electronic control unit ECU, wherein the decision is made as a function of the distance x1, x2 and a distance limit value, wherein in particular the distance limit value is specific for a boundary between a short range and a long range, wherein a final drivability corresponds to the first drivability if the distance x1, x2 is greater than, or in particular equal to, the distance limit value, or a final drivability corresponds to the second drivability if the distance x1, x2 is smaller than the distance limit value.

Furthermore, it is conceivable that, in particular after and/or as a function of classifying, the distance limit value is adjusted by the electronic control unit ECU, in particular during operation of the vehicle, wherein a first drivability and a second drivability are determined for different distances x1, x2, in particular for all distances x1, x2 to be traversed, and are compared with a last, in particular the last two or three, values for a determined height z300erm1, z300erm2, in particular in the short range.

In the context of the invention, it can be advantageous that, in particular after and/or as a function of classifying, a retraining is carried out, in particular during operation of the vehicle, wherein in particular the reference vector is readjusted as a function of a determined height z300erm1, z300erm2, which is in particular specific for a set of measurement data M1, M2 that is determined in a short range of the sensor and/or vehicle.

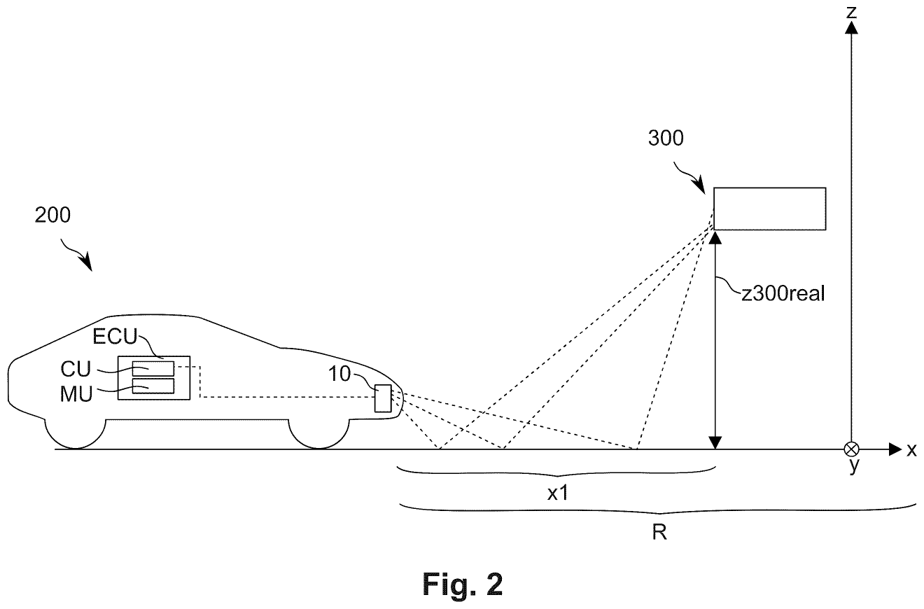

FIG. 2 shows a vehicle 200 comprising an electronic control unit ECU with a computing unit CU and a memory unit MU. In the electronic control unit ECU, in particular in the memory unit MU, the respective distance, in this case x1, and/or a determined height z300erm1 can be stored, which is in particular specific for a real or actual height z300real of the object 300. The vehicle 200 comprises a sensor 10, which is arranged, for example, in the front area of the vehicle 200 and preferably carries out a (cyclically repeated) radar measurement along the direction of travel x. In the process, respective sets of measurement data M1, M2 can be generated for different (discrete) distances x1, x2, in particular while the vehicle 200 is moving towards the object 300. Here, in particular over long distances, this can result in multiple reflections or multipath reflections (e.g. [but not only] on the ground, which is shown here coinciding with the direction of travel x) and/or a (resulting) signal distortion. As an example, three different transmission paths (dashed and/or reflected on the ground) are shown, which can cause such multiple reflections. These transmission paths can (after receiving a reflection) lead to different and/or ambiguous and/or distorted raw data/signals, which can be noticeable in particular in the long range. This can lead to a situation where determining the measured height is not possible, unreliable and/or (highly) erroneous. This can be at least partially compensated for by the above method by using the measurement data or variables inherent in the signals, which can be specific to the multipath reflections and/or signal distortions, for the classifying. In a short range, it may be provided that primarily and/or exclusively direct radar waves (without reflections from the ground) are reflected by the object 300. Thus, a distance measurement and/or height measurement can be comparatively very reliable and/or not erroneous. This enables the method to determine the drivability of the route section R in front of the vehicle. Here, the direction of travel x, the vertical z and/or the transverse direction y can form a right-handed system.

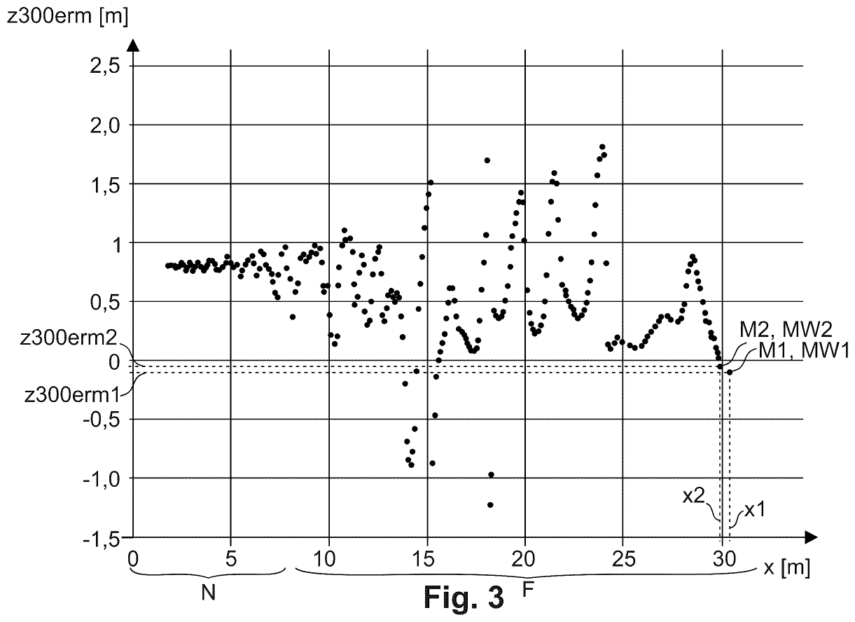

FIG. 3 shows an example of the determined height z300erm of the object 300 when the vehicle 200 approaches the object 300 in the direction of travel x. Here, the vehicle 200 or the sensor 10 is initially located in the long range F. As the vehicle 200 approaches the object 300, the distance x (plotted to the right) becomes smaller and smaller; for example, starting with a first distance x1 (at which a first set of measurement data M1 with measured values MW1 can be generated), a second distance x2 (at which a second set of measurement data M2 with measured values MW2 can be generated) can be generated in the next measurement cycle, and so on. As can be seen, here the course coming from large distances x can show a fluctuating course (inaccurate and/or unreliable and/or erroneous determined height z300erm). As soon as the object 300 enters the short range N, the determined height z300erm becomes more accurate and/or converges, in this case towards a value of approximately 0.66 m. Here, the course, in particular in the long range F, can be due to multipath reflections (see also FIG. 2). However, the multipath reflections and/or (corresponding) signal distortions can be used according to the above method in order to (nevertheless) obtain a (first) drivability, in particular by classifying 130 into classes K, in particular a first class K1 for drivable route sections and a second class K2 for non-drivable route sections, wherein preferably the (actual) determined height is not or does not have to be used. In other words, characteristics of the multi-path reflections that affect the measured signals can be used by the classifier to determine an initial drivability.

### LIST OF REFERENCE NUMBERS

105 defining the entries of the feature vector to be determined
106 training the classifier
110 providing at least two sets of measurement data
120 determining a feature vector
130 classifying the feature vector
131 assigning to at least two classes
135 determining a second drivability
137 deciding
138 adjusting the distance limit value
140 retraining
10 sensor
200 vehicle
300 object
ECU electronic control unit
CU computing unit
MU memory unit
M1, M2 sets of measurement data
MW1, MW2 measured values
MD1, MD2 measurement data
V feature vector
V1, V2 entry of the feature vector
Vref reference feature vector
K classifier
K1, K2 classes
K1 first class
K2 second class
N short range
F long range
R route section
X direction of travel
x1, x2 distance between sensor and object
y transverse direction (from right to left)
z vertical (from bottom to top)
z300real actual height of the object
z300erm1, z300erm2 determined height of the object for a distance x1, x2

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for determining the drivability of a route section by a vehicle, the method comprising:
providing at least two sets of measurement data to an electronic control unit, each of the at least two sets of measurement data comprising:
measured values including raw data or a determined height of the object from at least one measurement cycle of a radar measurement by a sensor of the vehicle, the measured values being specific for a certain distance of the sensor from the object along the direction of travel, and
at least two measurement data specific to the measured values,
determining a feature vector using an electronic control unit, the feature vector having at least one entry, the at least one entry being calculated as a function of the at least two measurement data, and
classifying the feature vector using the electronic control unit and a trained classifier in order to determine a first drivability of the route section; and
wherein the route section has at least one object with an actual height, wherein the actual height of the object extends at least in sections along a vertical, and wherein the object is located at least in sections in front of the vehicle in the direction of travel.

2. The method according to claim 1,
wherein the measurement data comprise at least one, optionally two or more, variables derived from the sets of measurement data selected from the group consisting of:
at least one variable derived from a respectively determined height,
at least one variable derived from a respectively determined signal-to-noise ratio, and
at least one derived variable, which is determined as a function of a number of targets in one or more bins of the measured values, a bin being specific to a section along the vertical defined in by the electronic control unit.

3. The method according to claim 1,
wherein the at least one entry of the feature vector is defined by training the classifier, wherein the at least one entry to be determined is determined by training as a function of a statistical significance for a first drivability of the route section.

4. The method according to claim 3,
wherein when determining or defining the at least one entry, optionally the one to be determined, using a mathematical combination, optionally a linear combination or multiplication, the step of determining or defining is carried out at least partially as a function of the at least two measurement data.

5. The method according to claim 1,
wherein the step of classifying comprises assigning to at least two classes, having:
a first class which is specific for route sections which can be traversed by the vehicle, optionally for a height which can be traversed by the vehicle with the first drivability being positive, and
a second class which is specific for route sections which cannot be traversed by the vehicle, optionally for a height which cannot be traversed by the vehicle with the first drivability being negative.

6. The method according to claim 1, wherein the step of classifying is carried out as a function of the feature vector and at least one reference feature vector, which is optionally determined by training.

7. The method according to claim 1, wherein the radar measurement comprises a distance-dependent signal distortion or a multipath reflection of radar waves, for which the measurement data are specific, wherein the classifier, during classifying or by training, is configured to detect the signal distortion or multipath reflection as a function of the feature vector, and wherein a classification into a first class and a second class is carried out.

8. The method according to claim 1, wherein:
determining of a second drivability of the route section is carried out by the electronic control unit as a function of a determined height of the object, the determined height comprising the measured values for a specific distance or determined as a function thereof, and wherein
a second drivability is positive if the determined height, optionally all determined heights, is greater than a height value specific to the vehicle or is less than a ground clearance value specific to the vehicle, and
a second drivability is negative if the determined height, optionally all determined heights, is less than a height value specific to the vehicle or is greater than a ground clearance value specific to the vehicle.

9. The method according to claim 1,
wherein after determining a second drivability of the route section, deciding is carried out by the electronic control unit, deciding being carried out as a function of the distance and a distance limit value, with, in particular, the distance limit value being specific for a boundary between a short range and a long range, and
wherein:
a final drivability corresponds to the first drivability if the distance is greater than or equal to the distance limit value, or
a final drivability corresponds to the second drivability if the distance is smaller than the distance limit value.

10. The method according to claim 1, wherein after or as a function of the classifying step, adjusting the distance limit value is carried out by the electronic control unit, optionally during operation of the vehicle, wherein for different distances, optionally for all distances to be traversed, in each case a first drivability and a second drivability are determined and compared with a last, optionally the last two or three, values for a determined height, optionally in the short range.

11. The method according to claim 1,
wherein after or as a function of the classifying step, retraining is carried out, optionally during operation of the vehicle, wherein the reference vector is readjusted as a function of a determined height, which is optionally specific for a set of measurement data which is determined in a short range.

12. A computer program product comprising commands which, when the computer program product is executed by a computer, cause the computer to implement the method according to claim 1.

13. A computer-readable data carrier in which commands are stored which, when executed by a computer, cause the computer to carry out the method according to claim 1.

14. An electronic control unit comprising a computing unit and a memory unit, in which commands are stored which, when at least partially executed by the computing unit, carry out the method according to claim 1.

15. A vehicle comprising an electronic control unit configured to carry out the method according to claim 1.
